(19) United States
(12) Patent Application Publication
(10) Pub. No.: US 2006/0011450 A1
(43) Pub. Date: Jan. 19, 2006

(54) Drive belt for a passenger conveyor

(76) Inventors: Richard N Fargo, Plainville, CT (US); John Milton Benoit, Springfield, MA (US); John P Wesson, Vernon, CT (US)

Correspondence Address: David J. Gaskey;Carlson, Gaskey $ Olds, 400 w. maple rd suite 350, Birmingham, MI, 48009, US

(21) Appl. No.: 10/537,384

(22) PCT Filed: Jan. 7, 2003
(86) PCT No.: PCT/US03/00290

§ 371 Date: Jun. 3, 2005

(51) Int. Cl. B66B 21/00

(52) U.S. Cl. 198/330

(57) ABSTRACT

A passenger conveyor system (20) includes a drive module (40) that engages a step chain (30) to move steps (22) as desired. A non-metallic drive belt (50) includes a unique configuration of teeth (60) that engage teeth (70, 80) of the step chain (30). In one example, the drive belt teeth (60) include a projection (64) that provides the initial engagement point with the step chain teeth (70, 80). In another example, the teeth (60) include a generally concave step chain link teeth engaging surface (62). The inventive arrangement provides smoother, quieter system operation and minimizes the separating forces that otherwise tend to occur between the belt and the step chain links.

### BACKGROUND OF THE INVENTION

1. Field of the Invention

This invention generally relates to passenger conveyors. More particularly, this invention relates to a drive belt for a passenger conveyor.

2. Description of the Prior Art

Passenger conveyors typically include a plurality of steps that move along a path to carry passengers from one location to another such as between floors in a building. Typical arrangements include a step chain having a plurality of links associated with the steps. The step chain moves in a loop corresponding to the loop followed by the steps. In a linear-engagement system, a drive mechanism typically includes a motor and a drive chain or belt that engages the step chain to cause the desired movement of the steps.

The interaction between the step chain links and the drive chain poses design challenges. For example, much of the vibration or noise of a linear-engagement escalator system is associated with the interaction between the drive chain or belt and the step chain. When the teeth on each are not appropriately sized, there are interferences which must be accommodated.

Another difficulty is addressing separation between the drive chain or belt and the step chain and accommodating the resulting forces upon the step chain and the surrounding structure. Another difficulty is caused by the rapid transition of each tooth from an unloaded state to a fully loaded state and then back to a fully unloaded state, at the beginning and end of the region where the step chain links are engaged by the drive chain or belt.

Those skilled in the art are always striving to make improvements. This invention includes using a drive belt that includes a unique tooth configuration that enhances the quality of system operation.

### SUMMARY OF THE INVENTION

In general terms, this invention is a drive belt for a passenger conveyor that includes a unique tooth configuration that facilitates better interaction between step chain links and the drive belt.

In one example drive belt designed according to this invention, the belt has an inner side that is adapted to engage a drive member, such as a drive sheave of a drive mechanism. An outer side includes a plurality of teeth that are adapted to engage a corresponding portion of a step chain (i.e., teeth on step chain links). The teeth on the outer side of the belt have a compressible projection near an end of the teeth distal from the body.

Another example belt designed according to this invention includes teeth that have a generally concave engaging surface that is adapted to engage the teeth on the step chain links. In one particular example, the concave engaging surface includes three different radii of curvature selected and oriented to provide optimal engagement and disengagement with the step chain link teeth during system operation.

The inventive tooth profile minimizes vibration by minimizing uneven loading and minimizes peak stress levels in the teeth.

In one example, step chain link teeth are provided with a surface contour that cooperates with the engaging surface contour of the belt teeth to minimize separating forces that otherwise tend to urge the step chain links away from the drive belt.

The various features and advantages of this invention will become apparent to those skilled in the art from the following detailed description of the currently preferred embodiments. The drawings that accompany the detailed description can be briefly described as follows.

### BRIEF DESCRIPTION OF THE DRAWINGS

FIG. 1 schematically illustrates a passenger conveyor having portions designed according to this invention.

FIG. 2 schematically illustrates an example belt configuration designed according to this invention.

FIG. 3 is a partial, cross-sectional illustration showing selected features of a drive belt tooth designed according to this invention.

FIG. 4 shows the embodiment of FIG. 3 under a second operating condition.

FIG. 5 shows an alternative belt tooth design and an alternative step chain link tooth design.

FIG. 6 schematically illustrates preferred dimensional features of one particular example drive belt tooth designed according to this invention.

### DETAILED DESCRIPTION OF THE PREFERRED EMBODIMENTS

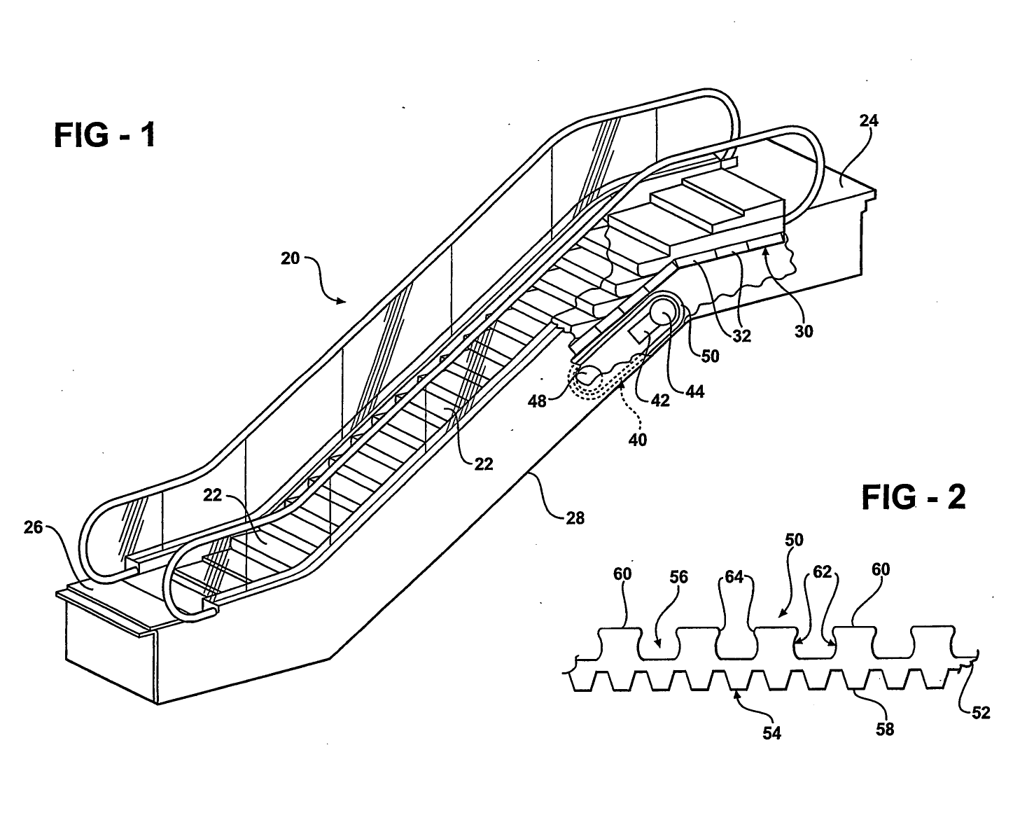

FIG. 1 schematically illustrates a passenger conveyor system 20, which is an escalator in this example. The invention, however, is not limited to escalators but is applicable to other types of passenger conveyors, such as moving walkways. The illustrated passenger conveyor system 20 includes a plurality of steps 22 that are movable along a loop so that the steps 22 carry passengers between landings 24 and 26.

A truss structure 28 supports the escalator system components in a known manner. A step chain 30 is associated with the steps 22 and is guided by the truss structure 28 in a known manner. The step chain 30 includes a plurality of step chain links 32.

A drive module 40 propels the step chain 30 and the steps 22 as required to move passengers between the landings 24 and 26. The drive module 40 includes a motor 42 that causes a drive sheave 44 to rotate at a desired speed. An idler sheave 48 rotates as known. Movement of the drive sheave 44 causes movement of a drive belt 50, which engages the step chain 30 for moving the steps 22 as desired.

The drive belt 46 preferably is made from load-bearing cords imbedded in a urethane material. A variety of such materials may be used and those skilled in the art who have the benefit of this description will be able to select the material to provide the desired strength and hardness characteristics to meet the needs of their particular situation.

As can be appreciated from FIGS. 2 and 3, the belt 50 has a body 52 with a first side 54 and a second side 56. The first side 54 is an inner side that is adapted to cooperate with the drive sheave 44 of the drive mechanism. In this example, the inner side 54 has a plurality of teeth 58 that engage corresponding teeth (not illustrated) on the drive sheave 44.

The second side 56 of the belt 50 includes a plurality of teeth 60 that are adapted to engage teeth 70 on the step chain links 32. In this example, the teeth 60 have a generally concave engaging surface 62. The teeth 60 in this example also include a projection 64 near an end of each tooth that is distal from the body 52. The engaging surface 62 and the projections 64 facilitate better interaction between the belt teeth 60 and the teeth 70 of the step chain links 32.

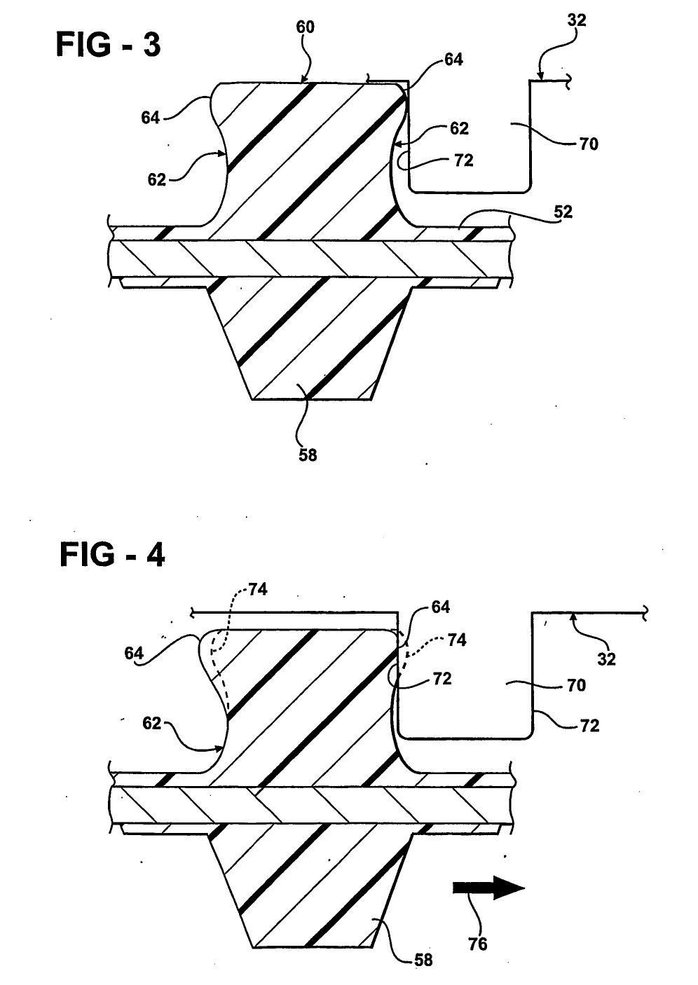

Referring to FIGS. 3 and 4, the projection 64 contacts an engaging surface 72 on the step chain link tooth 70 before any other portion of the tooth 60 makes such contact. The projection 64 preferably is compressible or pliable so that at least a portion of the tooth 60 in the vicinity of the projection 64 deforms elastically responsive to contact with the tooth 70. FIG. 4 schematically shows an example deformation where the shape of the tooth 60 is shown in phantom at 74 prior to engagement with the tooth 70. In this particular example, the loaded edge of the tooth projection 64 compresses and partially shifts to the left (according to the drawing). The unloaded side (i.e., the left side of the tooth in FIG. 4) also effectively shifts slightly to the left (according to the drawing). In this example, the direction of the force applied by the belt 50 to the chain link is to the right according to the drawing as shown by the arrow 76.

The projections 64 are resilient and retain a non-compressed or non-deflected configuration when the teeth are not engaging one of the step chain link teeth 70.

The unique configuration of the engaging surfaces of the belt teeth 60 facilitates better interaction with the step chain link teeth 70. The inventive arrangement provides smoother, more reliable engagement between the belt 50 and the step chain links 32. The projections 64 provide an initial contact point to better distribute stress in the belt teeth 60. The projection 64 facilitates contact between the belt 50 and the step chain link teeth 70 at a substantially vertical section of each link tooth, which eliminates separating forces (except for possibly under high loading conditions). The compliance of the projections 64 allows for a gradual increase in tooth force as engagement between the belt and the step chain links occurs. This gradual force increase reduces force pulsations (i.e., smoothes the transitions of each tooth between unloaded and fully loaded states), which reduces vibrations in the passenger conveyor system. Upon full engagement with the corresponding step chain link tooth 70, the entire belt tooth 60 carries the load, which reduces stress concentrations at particular locations in the belt teeth. With prior arrangements, for example, an undesirably high load was placed at the base of the teeth. With such prior configurations, any separation forces tend to deflect the belt teeth and increase the separating forces. The inventive arrangement avoids those effects because of the contact point provided by the projection 64.

The projections 64 provide a contact point between the tooth engaging surface and the teeth 70 on the step chain links 32. With the inventive arrangement, the contact point is always near the tip of the teeth 60. Keeping the contact point near the top of the tooth effectively maintains a consistent tooth stiffness throughout the engagement between the belt and the step chain links. Additionally, keeping the contact point near the tip of the tooth keeps the stress levels within the belt teeth approximately the same and better distributed throughout the teeth during system operation.

The concave engaging surface 62 in some examples provides a clearance between the belt teeth and the step chain link teeth so that the only contact point is at the projections 64. Other profiles besides a concave surface may serve a similar purpose, however, the concave surface of the illustrated examples provides for a smooth transition along the surface of the teeth and allows for better distributing forces throughout the teeth.

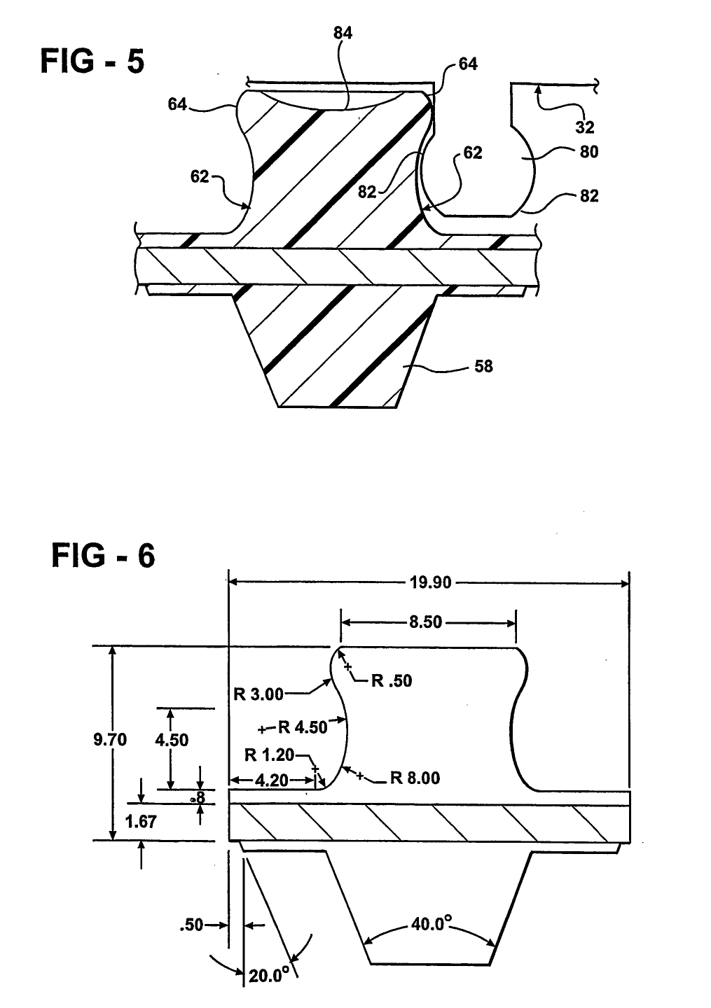

FIG. 5 shows another example arrangement where the step chain link tooth 80 is modified compared to that shown in FIGS. 3 and 4. The step chain link tooth 80 includes a convex surface 82 that is configured to cooperate with the concave engaging surface 62 on the belt tooth 60. This allows for at least a portion of the step chain link tooth 80 to be somewhat nestingly received against the engaging surface of the belt tooth. This engagement tends to further reduce separating forces that otherwise tend to urge the step chain links 32 away from the belt 50.

Another feature of the example of FIG. 5 is a relief 84 provided near the distal end of the tooth 60. In this example, the relief 84 comprises a portion where there is no belt material, which increases the compliance or flexibility of the top of the tooth. The example relief may be established during molding, for example. Such an embodiment has higher flexibility and provides an increased cushion effect during engagement between the projection 64 and the step chain link teeth 70.

The previously described examples each include an engaging surface on the belt teeth 60 that is at least partially, generally concave. FIG. 6 schematically illustrates a preferred arrangement having multiple radii of curvature along the engaging surface of the teeth 60. In this particular example, a first portion 90 of the engaging surface 62 has a first radius of curvature. A second portion 92 has a second radius of curvature. A third portion 94 has a third radius of curvature. The third portion 94 in this example preferably smoothly transitions into the projection 64, which in this example has two different radii of curvature.

In one particular example, the height of the tooth 60 as measured from the body 52 is approximately 7.22 mm. In this example, the first radius of curvature of the first portion 90 preferably is approximately 1.2 mm. The second radius of curvature of the second portion 92 preferably is approximately 8 mm. The third radius of curvature of the third portion 94 preferably is approximately 4.5 mm.

The radius of curvature of the projection 64 immediately adjacent the third portion 94 preferably is 3 mm. The second radius of curvature of the projection, closest to the distal end of the tooth, in this example preferably is 0.5 mm. In this particular example, the configuration of the engaging surface on the tooth 60 is designed to best distribute forces about the tooth 60, minimize separating forces between the step chain links and the belt and to provide smooth transitions at the loading and unloading (i.e., when the belt engages and then disengages the step chain links) during system operation.

While the example of FIG. 6 has particular dimensions, different sizes may be beneficial, depending on other system parameters. According to this invention, the dimensions and the choices for how many different radii of curvature along the surfaces preferably is selected to minimize stress levels in the teeth and to maintain consistent stress levels throughout the teeth. For example, through testing or modeling, if it is determined that one area of the tooth undergoes more stress than another, a radius of curvature in that one area may be increased to reduce the stress in that area. Of course, making such a change has an effect on other areas of the tooth and it is preferred to balance the dimensions so that stress distribution through the teeth is at a desirable level. Depending on the configuration of a particular system, different dimensions may provide different benefits. Those skilled in the art who have the benefit of this description will be able to select the dimensions to best meet the needs of their particular situation.

By selecting a most preferred dimensional arrangement of the belt teeth profile, not only are the stress levels within the teeth reduced but the amount of vibrations during system operation can be minimized. Some of the system vibration in conventional systems occurs because of the rapid loading at tooth engagement (i.e., when a belt tooth engages a step chain link tooth) and during unloading. The changing forces at these transitions tends to introduce vibrations. With the inventive arrangement, the forces and stress levels within the teeth remains more constant throughout the engagement, which reduces vibrations.

The inventive arrangement may also include other features that further enhance the smoothness of the system operation. As can be appreciated from any one of FIGS. 3-6, the belt 50 includes a plurality of cords 100, which in one example are made from steel. These cords provide reinforcement to the urethane material used to make the belt. Placing steel cords within such a material can be accomplished in a known manner.

One difficulty associated with such belts is that the method of manufacture and the presence of the steel cords within the belt during system operation tends to cause vibrations as the belt 50 wraps around the drive sheave 44 and the idler sheave 48. According to one method of manufacturing such a belt, the cords are supported in the machinery effectively at discrete points with controlled spacing between those points. At each of the supported points, there is a slight deviation or bump in the cords in the resulting belt. These bumps in the cords are one source of a polygon effect that introduces vibrations during system operation.

Another source of the polygon effect is the difference in compliance and support of the belt as it wraps around the drive pulley. Typically, the belt teeth or the gaps between the teeth are supported as the belt wraps around the pulleys in the drive mechanism, but both are not typically supported at the same time. The cords within the belt tend to bend at the locations between the teeth and tend to stay straight adjacent the base of the teeth. The inventive arrangements may include several approaches at minimizing the so-called polygon effect.

One approach is shown in FIG. 2 where the teeth 58 on the inner side 54 of the belt 50 have a different pitch than the teeth 60 on the outer side 56. In this example, the pitch of the teeth 58 is approximately one-half that of the teeth 60. Reducing the pitch of the inner teeth shortens the segments of the cords 100 between teeth. Reducing the tooth pitch on the inner side 54 of the belt significantly decreases the magnitude of vibrations associated with the polygon effect due to the belt wrapping around the sheaves. The pitch of the teeth 58 can be selected independently of the pitch of the teeth 60 in a belt designed according to this invention.

In one example, there is a 2:1 ratio between the pitch of the outer teeth and the pitch of the inner teeth. In one particular example, the pitch of the outer teeth 60 is 19.9 mm while the pitch of the inner teeth 58 is 9.95 mm. The pitch preferably is selected to provide adequate clearance for the belt teeth to fit between the link teeth (or the drive sheave teeth in the case of the inner teeth 58) and to accommodate link deflection that occurs during normal system operation. Those skilled in the art who have the benefit of this description and know the particular parameters of their own system will be able to select appropriate dimensions to meet the needs of their particular situation.

The preceding description is exemplary rather than limiting in nature. Variations and modifications to the disclosed examples may become apparent to those skilled in the art that do not necessarily depart from the scope of this invention. The scope of legal protection given to this invention can only be determined by studying the following claims.

We claim:

1. A drive belt for a passenger conveyor, comprising:
an inner side adapted to engage a drive member; and
an outer side including a plurality of teeth that are adapted to engage a corresponding portion of a step chain, the outer side teeth each including a base and a compressible projection distal from the base.

2. The belt of claim 1, wherein the compressible projections are rounded.

3. The belt of claim 1, wherein each of the teeth includes a generally concave surface extending between the projection and the base.

4. The belt of claim 1, wherein the teeth each have an engaging surface profile that includes the compressible projection, the engaging surface including a first concave portion having a first radius of curvature beginning adjacent the base, a second concave portion having a second radius of curvature adjacent the first portion and a third concave portion having a third radius of curvature extending between the second portion and the projection.

5. The belt of claim 4, wherein the teeth each have a height dimension and wherein the first radius of curvature is approximately one-sixth of the height dimension, the second radius of curvature is at least six times the first radius and the third radius of curvature is at least three times the first radius.

6. The belt of claim 4, wherein the projection has a first section with a first projection radius of curvature adjacent the third portion and a second section with a second projection radius of curvature extending between the first section and the distal end.

7. The belt of claim 6, wherein each of the teeth have a height dimension that is approximately 7 mm, the first radius is approximately 1.2 mm, the second radius is approximately 8 mm, the third radius is approximately 4.5 mm, the first projection radius is approximately 3 mm and the second projection radius is approximately 0.5 mm.

8. The belt of claim 1, wherein the teeth each include a relief near the projection that increases the compliance of the tooth near the projection.

9. The belt of claim 1, wherein the teeth comprise a urethane material.

10. The belt of claim 1, including a second plurality of teeth on the inner side and wherein the plurality of teeth on the outer side have a first pitch that is different than a second pitch of the second plurality of teeth.

11. The belt of claim 10, wherein the second pitch is finer than the first pitch.

12. The belt of claim 11, wherein the second pitch is approximately one-half of the first pitch.

13. A drive assembly for a passenger conveyor, comprising:
a step chain having a plurality of links each having a plurality of engaging members;
a drive mechanism; and
a belt having an inner side that cooperates with the drive mechanism and an outer side including a plurality of teeth having engaging surfaces that are at least partially concave and that cooperate with the engaging members on the step chain so that movement of the drive mechanism causes movement of the belt which causes movement of the step chain.

14. The assembly of claim 13, wherein the step chain engaging members include teeth having a convex surface that is at least partially received within the concave portion of the belt teeth engaging surfaces.

15. The assembly of claim 13, wherein the belt teeth each include a compressible projection near a distal end of the teeth.

16. The assembly of claim 15, wherein the teeth engaging surfaces include a first portion having a first radius of curvature, a second portion having a second radius of curvature adjacent the first portion and a third portion having a third radius of curvature extending between the second portion and the projection.

17. The assembly of claim 16, wherein the teeth each have a height dimension and wherein the first radius of curvature is approximately one-sixth of the height dimension, the second radius of curvature is at least six times the first radius and the third radius of curvature is at least three times the first radius.

18. The belt of claim 16, wherein the first, second and third portions establish the concave portion of the engaging surface and the projection establishes a convex portion of the engaging surface.

19. The assembly of claim 18, wherein the projection has a first section with a first projection radius of curvature adjacent the third portion and a second section with a second projection radius of curvature extending between the first section and the distal end.

20. The assembly of claim 19, wherein the height dimension is approximately 7 mm, the first radius is approximately 1.2 mm, the second radius is approximately 8 mm, the third radius is approximately 4.5 mm, the first projection radius is approximately 3 mm and the second projection radius is approximately 0.5 mm.

21. The belt of claim 13, including a second plurality of teeth on the inner side and wherein the plurality of teeth on the outer side have a first pitch that is different than a second pitch of the second plurality of teeth.

22. The belt of claim 21, wherein the second pitch is finer than the first pitch.
